(19) United States
(12) Patent Application Publication
(10) Pub. No.: US 2015/0045279 A1
(43) Pub. Date: Feb. 12, 2015

(54) Color-Protecting Detergent Or Cleaning Agent

(71) Applicants: BASF SE, Ludwigshafen (DE); HENKEL AG & Co. KGaA, Düsseldorf (DE)

(72) Inventors: Roland Ettl, Altlussheim (DE); Axel Wilms, Frankenthal (DE); Christian Schmidt, Ludwigshafen (DE); Markus Brym, Limburgerhof (DE); Birgit Glüsen, Dusseldorf (DE); Mareile Job, Leverkusen (DE); Ulrich Pegelow, Dusseldorf (DE); Carolin Trenka, Gmunden (AT)

(21) Appl. No.: 14/376,709

(22) PCT Filed: Feb. 12, 2013
(86) PCT No.: PCT/EP2013/052719

§ 371 Date: Aug. 5, 2014

(30) Foreign Application Priority Data
Feb. 13, 2012 (EP) 12155182.4

(51) Int. Cl. C11D 3/00; C08G 69/14; C08G 69/26; C11D 3/37

(52) U.S. Cl. CPC C11D 3/0021; C11D 3/3719; C08G 69/14; C08G 69/26
USPC 510/349; 510/276; 528/323; 528/310; 428/402

(57) ABSTRACT

Described are oligoamides that improve the color protection properties of detergents and cleaning agents during their use for washing or cleaning colored textile fabrics. The oligoamides are rich in amino groups.

### CROSS-REFERENCE TO RELATED APPLICATIONS

This application is the National State entry of PCT/EP2013/052719, filed on Feb. 12, 2013, which claims priority to European Application 12155182.4, filed on Feb. 13, 2012, the disclosures of which are incorporated herein by reference in their entireties.

### TECHNICAL FIELD

The present invention relates to the use of amino-group-rich oligoamides as color-transfer-inhibiting active ingredients during the washing and/or cleaning of textiles, and detergents or cleaners which comprise oligoamides of this type.

### BACKGROUND

Besides the ingredients that are indispensable for the washing or cleaning process, such as surfactants and builder materials, detergents and cleaners generally comprise further constituents which can be grouped together under the term washing auxiliaries and which comprise such different active ingredient groups as foam regulators, graying inhibitors, bleaches, bleach activators and enzymes. Auxiliaries of this kind also include substances which are intended to prevent colored textile sheet materials bringing about a changed color impression after the washing. This change in color impression of washed, i.e. clean, textiles can be based on the one hand on the fact that dye fractions are removed from the textile by virtue of the washing or cleaning process (“fading”), and on the other hand dyes detached from differently colored textiles can deposit themselves on the textile (“discoloration”). The same applies accordingly for the cleaning of hard surfaces. The discoloration aspect can also play a role in the case of noncolored laundry items if these are washed together with colored laundry items. In order to avoid these undesired secondary effects of removing dirt from textiles by treating with customarily surfactant-containing aqueous systems, detergents, particularly if they are provided as so-called color detergents for washing colored textiles, comprise active ingredients which are intended to prevent the detachment of dyes from the textile or at least avoid the settling of detached dyes present in the wash liquor on textiles. However, many of the customarily used—generally water-soluble—polymers have such a high affinity to dyes that they attract these to an increased extent from the colored fiber, meaning that their use results in color losses. Moreover, some conventional color transfer inhibitors only achieve results with some classes of dye and are unable to prevent the transfer of other classes of dye.

The patent application DE 42 35 798 discloses copolymers of N-vinylpyrrolidone, N-vinylimidazole, N-vinylimidazolium compounds or mixtures thereof, further nitrogen-containing, basic ethylenically unsaturated monomers and optionally other monoethylenically unsaturated monomers and their use for inhibiting dye transfer during the washing process. The patent application DE 196 21 509 describes polymers with an average molar mass above 50 000 g/mol of 5 to 20 mol % of N-vinylimidazole or 4-vinylpyridine N-oxide, 95 to 50 mol % of N-vinylpyrrolidone, N-vinyloxazolidones, methyl-N-vinylimidazole or mixtures thereof and up to 30 mol % of other monoethylenically unsaturated monomers for this purpose. The international patent application WO 03/062362 discloses water-insoluble substrates which carry polyamides as absorber materials for particulate dirt. The international patent application WO 2009/124908 describes the use of particulate water-insoluble polymers, including polyamide, for preventing the transfer of textile dyes from colored textiles to noncolored or differently colored textiles during their combined washing in particular surfactant-containing aqueous solutions. It is known from the international patent application WO 2009/127587 that porous polyamide particles with a certain particle diameter and a certain particle diameter distribution, certain specific surface area, certain oil absorption capacity and crystallinity avoid the transfer of textile dyes from colored textiles to noncolored or differently colored textiles during their combined washing in particular surfactant-containing aqueous solutions.

### SUMMARY

A first aspect of the present invention is directed to a detergent, washing additive composition, laundry pretreatment composition or cleaner. In a first embodiment, a detergent, washing additive composition, laundry pretreatment composition or cleaner, comprises a color transfer inhibitor in the form of an oligoamide, the oligoamide having at least 750 μmol/g of basic amino groups, as well as customary ingredients compatible with this constituent, wherein the oligoamide consists essentially of repeating units of formulae Ia and/or Ib and optionally branching units of formulae II and/or II′,

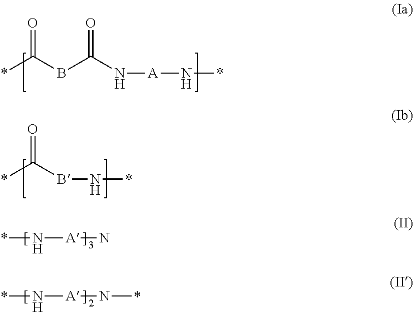

wherein

A is selected from alkanediyl radicals having 2 to 20 carbon atoms, wherein 1, 2, 3, 4 or 5 nonadjacent CH₂ groups can be replaced by a corresponding number of NH groups and/or in which 2 joined together CH₂ groups can be jointly replaced by a C₅-C₇-cycloalkanediyl group, and groups of the formula (A″-O)ₚ-A′, wherein A″ is C₂-C₄-alkanediyl, and p is an integer in the range from 1 to 20, wherein the repeating units A″-O can be identical or different;

A′ is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group;

B is selected from a covalent bond, alkanediyl having 1 to 20 carbon atoms, wherein 2 joined together CH₂ groups can be jointly replaced by a C₅-C₇-cycloalkanediyl group, and C₆-C₁₄-arylenediyl, which is unsubstituted or has 1 or 2 substituents, which are selected from C₁-C₄-alkyl, C₁-C₄-alkoxy and SO₃H, and

B′ is selected from alkanediyl radicals having 4 to 20 carbon atoms.

In a second embodiment, the composition of the first embodiment is modified, which comprises 0.05% by weight to 20% by weight the oligoamide.

In a third embodiment, the composition of the first and second embodiments is modified, which comprises the oligoamide applied to a water-insoluble cloth.

A second aspect of the invention relates to a method. In a fourth embodiment, a method of preparing a textile detergent composition, comprises providing a textile detergent composition and adding the oligoamide of the first through third embodiments.

A third aspect of the invention relates to a method. In a fifth embodiment, a method of avoiding the transfer of textile dyes from colored textiles to uncolored or differently colored textiles, comprises providing a surfactant-containing aqueous solutions, and adding the oligoamide of the first through third embodiments.

A fourth aspect of the invention relates to a method. In a sixth embodiment, a method for washing colored textiles in surfactant-containing aqueous solutions, the comprises providing a surfactant-containing aqueous solution comprising the oligoamide of the first through third embodiments, adding a colored textile, and washing the color textile.

In a seventh embodiment, the composition of the first through third embodiments is modified, wherein the oligoamides are obtained by reacting a) at least one amino compound having 2 primary amino groups selected from compounds of the formula V1

H₂N-A-NH₂ (V1)

wherein A is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A″, in which A″ is C₂-C₄-alkanediyl and p is an integer in the range from 1 to 20, where the repeat units A″-O can be identical or different,

with b) at least one amide-forming compound selected from dicarboxylic acids, their amide-forming derivatives, and lactams.

In an eighth embodiment, the composition of the seventh embodiment is modified, wherein the amide-forming compound is selected from dicarboxylic acids of the formula V2

HOOC—B—COOH (V2)

and amide-forming derivatives thereof, wherein B is selected from a covalent bond, alkanediyl radicals having 1 to 20 carbon atoms, wherein 2 joined together CH₂ groups can be jointly replaced by a C₅-C₇-cycloalkanediyl group, and arylene, which is unsubstituted or has 1, 2 or 3 substituents, which are selected from C₁-C₄-alkyl, C₁-C₄-alkoxy and SO₃H.

In a ninth embodiment, the composition of the seventh embodiment is modified, wherein the amide-forming compound is selected from lactams and mixtures thereof with dicarboxylic acids or with amide-forming derivatives thereof.

In a tenth embodiment, the composition of the seventh embodiment is modified, wherein the oligoamides have at least one of the following features i) to iv): i) the oligoamides are water-insoluble and particulate, wherein the oligoamide particles have particle sizes in the range from 1 nm to 500 μm, ii) the oligoamides are water-insoluble and particulate, where the average particle size (weight-average) of the oligoamide particles is in the range from 5 nm to 100 μm, iii) the oligoamides have less than 100 μm/g of carboxyl groups, and iv) the oligoamides have a number-average molecular weight in the range from 200 g/mol to 5000 g/mol.

An additional aspect of the present invention is directed to an oligoamide. In an eleventh embodiment, an oligoamide having at least 750 μmol/g of basic amino groups and a number-average molecular weight in the range from 200 g/mol to 5000 g/mol, consists essentially of repeating units of formulae Ia and/or Ib and optionally branching units of formulae II and/or II′,

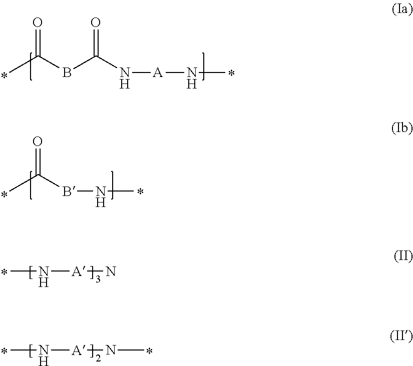

wherein

A is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A′, in which A″ is C₂-C₄-alkanediyl, and p is an integer in the range from 1 to 20, where the repeat units A″-O can be identical or different,

A′ is selected from alkanediyl radicals having 1 to 20 carbon atoms, wherein 1, 2, 3, 4 or 5 nonadjacent CH₂ groups are replaced by a corresponding number of NH groups, and/or in which 2 joined together CH₂ groups are jointly replaced by a C₅-C₇-cycloalkanediyl group;

B is selected from a covalent bond, alkanediyl radicals having 1 to 20 carbon atoms, wherein 2 joined together CH₂ groups are jointly replaced by a C₅-C₇-cycloalkanediyl group, and C₆-C₁₄-arylenediyl, which is unsubstituted or has 1 or 2 substituents, which are selected from C₁-C₄-alkyl, C₁-C₄-alkoxy and SO₃H, and

B′ is selected from alkanediyl radicals having 4 to 20 carbon atoms.

In a twelfth embodiment, the oligoamide of the eleventh embodiment is modified, wherein the oligoamide is obtained by reacting a) at least one amino compound having 2 primary amino groups selected from compounds of the formula V1

H₂N-A-NH₂ (V1)

wherein A is selected from alkanediyl radicals having 2 to 20 carbon atoms, wherein 1, 2, 3, 4 or 5 nonadjacent CH₂ groups are replaced by a corresponding number of NH groups, and/or in which 2 joined together CH₂ groups are jointly replaced by a C₅-C₇-cycloalkanediyl group, and groups of the formula (A″-O)ₚ-A″, in which A″ is C₂-C₄-alkanediyl and p is an integer in the range from 1 to 20, wherein the repeating units A″-O can be identical or different,

with b) at least one amide-forming compound selected from dicarboxylic acids, their amide-forming derivatives and lactams.

In a thirteenth embodiment, the oligoamide of the twelfth embodiment is modified, wherein the amide-forming compound is selected from dicarboxylic acids of the formula V2

HOOC—B—COOH (V2)

and amide-forming derivatives thereof, wherein B is selected from a covalent bond,
alkanediyl radicals having 1 to 20 carbon atoms, in which 2 joined together CH₂ groups are jointly replaced by a C₅-C₇-cycloalkanediyl group, and arylene, which is unsubstituted or has 1, 2 or 3 substituents, which are selected from C₁-C₄-alkyl, C₁-C₄-alkoxy and SO₃H.

In a fourteenth embodiment, the oligoamide of the twelfth embodiment is modified, wherein the amide-forming compound is selected from lactams and mixtures thereof with dicarboxylic acids or with amide-forming derivatives thereof.

In a fifteenth embodiment, the oligoamide the eleventh through fourteenth embodiments is modified, wherein the oligoamide has at least one of the following features i) to iv): i) the oligoamides are water-insoluble and particulate, wherein the oligoamide particles have particle sizes in the range from 1 nm to 500 μm, ii) the oligoamides are water-insoluble and particulate, wherein the average particle size (weight-average) of the oligoamide particles is in the range from 5 nm to 100 μm; iii) the oligoamides have less than 100 μm/g of carboxyl groups, and iv) the oligoamides have a number-average molecular weight in the range from 200 g/mol to 5000 g/mol.

In a sixteenth embodiment, the composition of the eighth embodiment is modified, wherein B is 1,4-butanediyl.

In a seventeenth embodiment, the composition of the ninth embodiment is modified, wherein the lactam comprises caprolactam.

In an eighteenth embodiment, the oligoamide of the thirteenth embodiment is modified, wherein B is 1,4-butanediyl.

In nineteenth embodiment, the oligoamide of the fourteenth embodiment is modified, wherein the lactam comprises caprolactam.

### DETAILED DESCRIPTION

Surprisingly, it has been found that a particularly good color transfer inhibition arises through the use of amino-group-rich oligoamides.

Provided is the use of oligoamides, which have at least 200 μmol/g of basic amino groups, for avoiding the transfer of textile dyes from colored textiles to noncolored or differently colored textiles during their combined washing in particular surfactant-containing aqueous solutions.

The oligoamides as such are novel in particular if their number-average molecular weight (Mₙ) is in the range from 200 g/mol to 5000 g/mol. Consequently, the invention also provides oligoamides which have at least 250 μmol/g of basic amino groups and a number-average molecular weight in the range from 200 g/mol to 5000 g/mol, where the oligoamides consist essentially of aliphatic repeat units and optionally cycloaliphatic and/or aromatic repeat units.

In one or more embodiments, the oligoamides have at least 250 μmol/g, particularly at least 500 μmol/g and in particular at least 750 μmol/g of basic amino groups. In this connection, basic amino groups are understood as meaning those which can be determined by means of titration with aqueous hydrochloric acid solution.

In one or more embodiments, the oligoamides have a number-average molecular weight (Mₙ) in the range from 200 g/mol to 5000 g/mol and in particular from 500 g/mol to 3000 g/mol. In one or more embodiments, their weight-average molecular weight (M_{w}) is in the range from 400 g/mol to 20 000 g/mol and in particular from 200 g/mol to 10 000 g/mol. The polydispersity index M_{w}/Mₙ characterizing the molecular weight distribution is typically a number in the range from 2 to 6, specifically in the range from 2 to 5 and in particular in the range from 2 to 4. The viscosity number of the oligoamides according to the invention, which can be determined analogously to DIN 53 727, is generally in the range from 2 to 100, specifically in the range from 3 to 75 and in particular in the range from 5 to 60.

Furthermore, in one or more embodiments, the oligoamides of the present invention have less than 300 μmol/g, particularly less than 100 μmol/g and in particular less than 50 μmol/g, of free carboxyl groups. Accordingly, according to one embodiment of the invention, the ratio of terminal amino groups to terminal carboxyl groups in the oligoamides is greater than or equal to 1, specifically greater than 2 and in particular greater than 5.

In one or more embodiments, the monomer units of which the oligoamides of the present invention comprise either those which are derived from aliphatic or cycloaliphatic diamines and aliphatic or cycloaliphatic dicarboxylic acids, or those which are derived from w-aminocarboxylic acids or lactams thereof. Besides these bifunctional monomer units, ones may also be additionally present which are derived from monomers with further amino groups and/or carboxyl groups, such as, for example, triamines or diaminocarboxylic acids.

A further parameter suitable for characterizing an oligoamide according to the invention is the molar ratio of amino groups to carboxyl groups, including the derivatized amino groups or carboxyl groups capable of forming the amide, in the totality of the monomers which form the basis of the oligoamide. Typically, this molar ratio is in the range from 0.9:1 to 25:1, specifically in the range from 1.1:1 to 15:1 and in particular in the range from 1.25:1 to 10:1.

The oligoamides can be present as linear or branched oligomers which can optionally be additionally crosslinked.

According to a specific embodiment, the oligoamides are branched. In this connection, the branching points are nitrogen atoms of a tertiary amino group or of a disubstituted amide group. If the oligoamides are branched, their degree of branching is typically in the range from 0.05 mol/kg to 15 mol/kg, specifically in the range from 0.1 to 7.5 mol/kg and in particular in the range from 0.2 to 4 mol/kg. According to another embodiment, the oligoamides of the present invention are linear. According to further embodiment, the oligoamides of the present invention are crosslinked. In one or more embodiments, the oligoamides are prepared from aliphatic and optionally cycloaliphatic and/or aromatic monomers. This gives rise to the fact that the oligoamides consist essentially of aliphatic repeat units and optionally cycloaliphatic and/or aromatic repeat units. This is to be understood as meaning that the molecular moieties of the oligoamides which join the functional groups, thus for example amino groups and in particular carboxamide groups, with one another are aliphatic, cycloaliphatic and/or aromatic.

In one or more embodiments, the oligoamides of the present invention consist essentially of repeat units of the formulae Ia and/or Ib, and optionally branching units of the formulae II and/or II′,

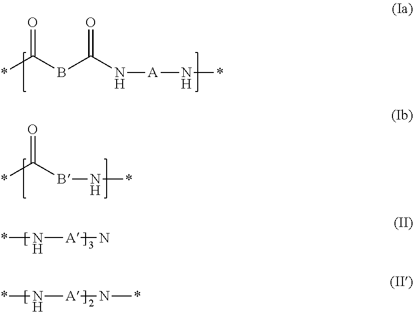

in which

A is selected from alkanediyl radicals having 2 to 20 carbon atoms, in which 1, 2, 3, 4 or 5 nonadjacent CH₂ groups can be replaced by a corresponding number of NH groups, and/or in which two joined together CH₂ groups can be jointly replaced by a C₅-C₇-cycloalkanediyl group, and groups of the formula (A″-O)ₚ-A′, in which A″ is C₂-C₄-alkanediyl, and p is an integer in the range from 1 to 20, where the repeat units A″-O can be identical or different,

A′ is selected from alkanediyl radicals having 2 to 20 carbon atoms, in which 1, 2, 3, 4 or 5 nonadjacent CH₂ groups can be replaced by a corresponding number of NH groups, and/or in which two joined together CH₂ groups can be replaced jointly by a C₅-C₇-cycloalkanediyl group,

B is selected from a covalent bond, alkanediyl radicals having 1 to 20 carbon atoms, in which 2 joined together CH₂ groups can be jointly replaced by a C₅-C₇-cycloalkanediyl group, and

B′ is selected from alkanediyl radicals having 4 to 20 carbon atoms.

The repeat units Ia and Ib generally go back to the oligomerization of diamines and dicarboxylic acids or aminocarboxylic acids or lactams thereof. The repeat units II and II′ are usually attributed to an oligomerization in the presence of amino compounds with one secondary and two primary amino groups or with one tertiary and 3 primary amino groups.

The term “alkanediyl radical having 2 to 20 carbon atoms”, as used herein, refers to a bivalent group derived from a straight-chain or branched C₂-C₂₀-alkane, such as, for example, methylene, 1,2-ethanediyl, 1,2-propanediyl, 1,3-propanediyl, 1,2-butanediyl, 1,3-butanediyl, 1,4-butanediyl, 2-methyl-1,2-propanediyl, 1,6-hexanediyl, 1,7-heptane-diyl, 1,9-nonanediyl, 1,12-dodecanediyl.

The term “C₅-C₇-cycloalkanediyl group”, as used herein, refers to a bivalent group derived from a cycloalkane having 5 to 7 carbon atoms, such as, for example, 1,2-cyclo-pentanediyl, 1,3-cyclopentanediyl, 1,2-cyclohexanediyl, 1,3-cyclohexanediyl, 1,4-cyclohexanediyl or 1,4-cycloheptanediyl.

In one or more embodiments, in the repeat unit of formula Ia, the radical A is selected from C₂-C₁₀-alkanediyl, C₅-C₂₀-alkanediyl in which 1, 2, 3 or 4 nonadjacent CH₂ groups are in case replaced by NH groups, and groups of the formula (A″-O)ₚ-A′, in which A″ is 1,2-ethanediyl, 1,2-propanediyl, 1,3-propanediyl or 1,4-butanediyl, A′ is a radical A specified as being preferred and p is an integer in the range from 1 to 10.

In this connection, the radicals A from the group of the C₂-C₁₀-alkanediyls are selected in particular from C₂-C₈-alkanediyl, specifically from 1,2-ethanediyl, 1,2-propanediyl, 1,3-propanediyl, 1,3-butanediyl, 1,4-butanediyl, 2-methyl-1,2-propanediyl, 1,6-hexanediyl, 1,7-heptanediyl, 1,6-heptanediyl and 1,8-octanediyl and particularly from 1,4-butanediyl, 1,5-heptanediyl, 1,6-hexanediyl and 1,7-heptanediyl.

The radicals A from the group of the C₅-C₂₀-alkanediyls, which have in each case NH groups instead of 1, 2, 3 or 4 nonadjacent CH₂ groups, are selected in particular from radicals of the formula [(C₂-C₈)-alkanediyl-NH]ₒ—(C₃-C₈)-alkanediyl where the alkanediyl units are selected independently of one another and o is an integer in the range from 1 to 10 and preferably from 1 to 6. Specifically, such radicals A are selected from radicals of the formula [(C₂-C₆)-alkanediyl-NH]ₒ—(C₃-C₆)-alkanediyl where o is 1, 2 or 3, particularly from (C₂-C₆)-alkanediyl-NH—(C₃-C₆)-alkanediyl, for example 1,6-hexanediyl-NH-1,6-hexanediyl or 1,3-propanediyl-NH-1,3-propanediyl, and [(C₂-C₆)-alkanediyl-NH]₂—(C₃-C₆)-alkanediyl, for example 1,3-propanediyl-NH-1,2-ethanediyl-NH-1,3-propanediyl.

The aforementioned radicals A of the formula (A″-O)ₚ-A′ are selected in particular from (1,2-propanediyl-O)_{q}-1,2-propanediyl, (1,2-ethanediyl-O)_{q}-1,2-ethanediyl, where q is in each case 3, 4, 5, 6, 7 or 8, and (C₂-C₆)-alkanediyl-O—[(C₂-C₆)-alkanediyl-O]_{f}—(C₂-C₆)-alkanediyl, where r is 1, 2, 3 or 4. Particularly, such radicals A are selected from (1,2-propanediyl-O)_{q}-1,2-propanediyl, where q is 4, 5, 6 or 7, and (C₃-C₅)-alkanediyl-O-[(C₂-C₅)-alkanediyl-O]ᵣ—(C₃-C₅)-alkanediyl, where r is 1, 2 or 3, specifically from (1,2-propanediyl-O)_{q}-1,2-propanediyl where q is 5 or 6, 4,9-dioxadodecane-1,12-diaminyl and 4,7,10-trioxatridecane-1,13-diaminyl.

In one or more embodiments, in the repeat units of the formulae II and II′ the radicals A′, independently of one another, are selected from the radicals specified as being preferred for the radical A.

In addition to the aforementioned repeat units, the oligoamides of the present invention can also comprise repeat units which differ from those of the formula Ia in that the unit-NH-A-NH— is replaced by a bivalent heterocyclyl radical having at least 2 nitrogen atoms in the ring and an optional (C₁-C₁₀)-aminoalkyl substituent. The term “heterocyclyl” refers here to a 5- or 6-membered monocyclic or an 8- to 10-membered bicyclic heterocyclic radical which comprises 2 nitrogen atoms and optionally 1 or 2 further heteroatoms selected from N, O and S as ring atoms, where the heterocyclic radical can be saturated, partially saturated or aromatic. Within the oligoamide, the heterocyclic radical is bonded either via two ring nitrogen atoms or via one ring nitrogen atom and the nitrogen atom of the optional aminoalkyl group. The heterocyclic radical is therefore preferably derived from heterocycles which comprise either two secondary amino groups or, if it is substituted with an aminoalkyl group, one secondary amino group. Examples of such heterocycles are imidazole, pyrazole, triazole, tetrazole, benzimidazole, purine and piperazine.

In one or more embodiments, the specified repeat units comprising one bivalent heterocyclyl unit are selected from monocyclic saturated and partially saturated 5- or 6-membered monocyclic heterocycles having 2 nitrogens, such as piperazine, and monocyclic partially saturated and aromatic 5- or 6-membered monocyclic heterocycles having 2 nitrogen atoms which are N-substituted with a (C₁-C₁₀)-aminoalkyl group, such as N-(3-aminopropyl)imidazole.

In one or more embodiments, in the repeat unit of the formula Ia, the radical B is selected from a covalent bond and C₁-C₁₀-alkanediyl. In particular, B is selected from C₁-C₇-alkanediyl, specifically from methylene, 1,2-ethanediyl, 1,2-propanediyl, 1,3-propanediyl, 1,3-butanediyl, 1,4-butanediyl, 2-methyl-1,2-propanediyl, 1,5-pentanediyl, 1,6-hexanediyl and 1,7-heptanediyl, particularly from 1,3-propanediyl, 1,4-butanediyl, 1,5-heptanediyl and 1,6-hexanediyl. In specific embodiments, B is 1,4-butanediyl.

In one or more embodiments, in the repeat unit of the formula Ib, the radical B′ is selected from C₄-C₁₀-alkanediyl, in particular from C₄-C₆-alkanediyl, specifically from 1,4-butanediyl, 1,5-pentanediyl and 1,6-hexanediyl, and B′, in specific embodiments, is 1,6-hexanediyl.

In addition to the meanings specified above for the radical B, B can also be selected from the group of the bivalent C₆-C₁₄-arylene radicals, i.e. the group of C₆-C₁₄-arylenediyls, which are bivalent mono- or polycyclic aromatic hydrocarbons. The C₆-C₁₄-arylenediyls can be unsubstituted or have 1 or 2 substituents which are selected from C₁-C₄-alkyl, C₁-C₄-alkoxy and SO₃H, in particular from C₁-C₂-alkyl, C₁-C₂-alkoxy and SO₃H. In one or more embodiments, radicals B from the group of the C₆-C₁₄-arylenediyls are selected from C₆-C₁₀-arylenediyl, specifically from 1,3-phenylene, 1,4-phenylene, 1,4-naphthylene, 1,3-naphthylene, 1,5-naphthylene, 2,6-naphthylene, 2,7-naphthylene and 1,6-naphthylene, which are unsubstituted or have 1 or 2 substituents selected from methyl, ethyl, methoxy and SO₃H.

The oligoamides of the present invention can be prepared by the processes known from the prior art for the preparation of polyamides and oligoamides. Of suitability for this purpose are in particular polycondensation reactions of monomers which comprise primary or secondary amino groups or isocyanate groups and/or carboxyl groups or amide-forming groups derived therefrom. Preference is given to monomers M1 with two or more, in particular two or three, primary amino groups or isocyanate groups, monomers M2 with two or three, in particular two, carboxyl groups or amide-forming groups derived therefrom, and monomers M3, which are either compounds with one or two, in particular with one, primary amino group or isocyanate group and with one or two, in particular one, carboxyl group or a corresponding amide-forming group, or lactams derived from these compounds. Hereinbelow, the monomers M2 and M3 are collectively referred to as amide-forming compounds.

The monomers M1 used are in particular aliphatic and optionally cycloaliphatic and/or aromatic di- and triamines with two or three, in particular two, primary amino groups.

According to a specific embodiment of the invention, monomers M1 are selected from diamines of the formula V1,

H₂N-A-NH₂ (V1)

in which the bivalent radical A has the meanings described above, in particular the meanings specified herein as being preferred. Particularly preferred monomers M1 are diamines V1, in which A is 1,4-butanediyl, 1,5-pentanediyl, 1,6-hexanediyl or 1,7-heptanediyl and specifically 1,6-hexanediyl. These preferred monomers M1 are accordingly 1,4-diaminobutane, 1,5-diaminopentane, 1,6-diaminohexane or 1,7-diaminoheptane and specifically 1,6-diaminohexane.

Suitable further monomers having at least two amino groups for the preparation of the oligoamides are also the above-described heterocycles, which either comprise two secondary amine groups or, if they are substituted with a (C₁-C₁₀)-aminoalkyl group, a secondary amino group. In the text below, such heterocycles are referred to as monomers M1′. Preferred monomers M1′ are saturated and partially saturated 6-membered rings which comprise two secondary amino groups as ring members, in particular piperazine, and aromatic 5- or 6-membered rings with one secondary and one tertiary amino group, and also an N-linked (C₁-C₆)-aminoalkyl group, in particular the N—(C₁-C₆)-aminoalkyl-substituted derivatives of imidazole, pyrazole, triazole, tetrazole, benzimidazole, purine and piperazine, specifically N-(3-aminopropyl)imidazole.

Monomers M2 used are in particular aliphatic and optionally cycloaliphatic and/or aromatic dicarboxylic acids and amide-forming derivatives thereof. The amide-forming derivatives are in particular the aforementioned dicarboxylic acids in which one or both carboxyl groups are replaced by ester groups, nitrile groups, carboxylic anhydride groups and carboxylic acid halide groups, preferably carbonyl chloride groups.

According to a specific embodiment of the invention, monomers M2 are selected from dicarboxylic acids of the formula V2,

HOOC—B—COOH (V2)

and amide-forming derivatives thereof, in which B is selected from a covalent bond, alkanediyl radicals having 1 to 20 carbon atoms, in which two joined together CH₂ groups can be jointly replaced by a C₅-C₇-cycloalkanediyl group, and arylene, which is unsubstituted or has 1, 2 or 3 substituents which are selected from C₁-C₄-alkyl, C₁-C₄-alkoxy and SO₃H.

In one or more embodiments, monomers M2 are dicarboxylic acids V2 and amide-forming derivatives thereof in which B is selected from a covalent bond and C₁-C₁₀-alkanediyl, in particular from C₁-C₇-alkanediyl, specifically from methylene, 1,2-ethanediyl, 1,2-propanediyl, 1,3-propanediyl, 1,3-butanediyl, 1,4-butanediyl, 2-methyl-1,2-propanediyl, 1,5-pentanediyl, 1,6-hexanediyl and 1,7-heptanediyl, particularly preferably from 1,3-propanediyl, 1,4-butanediyl, 1,5-heptanediyl and 1,6-hexanediyl. Particularly preferred monomers are dicarboxylic acids V2 and amide-forming derivatives thereof in which B is 1,4-butanediyl. This particularly preferred monomer M2 is accordingly adipic acid and amide-forming derivatives thereof.

The monomers M3 used are in particular aliphatic w-aminocarboxylic acids with 4, 5 or 6 carbon atoms and lactams thereof. In one or more embodiments, monomers M3 are 4-aminobutanoic acid, 5-aminopentanoic acid and 6-aminohexanoic acid, and lactams thereof pyrrolidin-2-one, piperidin-2-one and ε-caprolactam. Particularly preferred monomers M3 are 6-aminohexanoic acid, pyrrolidin-2-one, piperidin-2-one and ε-caprolactam, and specifically ε-caprolactam.

In one or more embodiments, the oligoamides of the present invention are obtainable by reacting monomers comprising at least one amino compound which has two primary amino groups, and at least one amide-forming compound which is selected from dicarboxylic acids, amide-forming derivatives thereof and lactams.

According to a specific embodiment, the at least one amino compound with 2 primary amino groups is selected from monomers M1 and particularly from diamines of the formula V1, and it is reacted with at least one dicarboxylic acid, preferably selected from dicarboxylic acids of the formula V2 or an amide-forming derivative thereof. In this embodiment, the at least one amino compound is used, based on 1 mol of the at least one dicarboxylic acid, usually in an amount of more than 1 mol, preferably of more than 1.1 mol, in particular of more than 1.25 mol and particularly preferably of more than 2 mol.

The reactions according to the above specific embodiment are carried out with one or two different and particularly preferably with one dicarboxylic acid or an amide-forming derivative thereof. If the reactions are carried out with two different dicarboxylic acids or amide-forming derivatives thereof, their molar ratio is generally in the range from 20:1 to 1:1, preferably in the range from 15:1 to 1:1 and in particular in the range from 10:1 to 1:1.

In the reactions according to the above specific embodiment, the dicarboxylic acids are selected from adipic acid, an amide-forming adipic acid derivative and mixtures thereof with a further different dicarboxylic acid V2 or amide-forming derivative thereof.

According to a further specific embodiment, the at least one amino compound with 2 primary amino groups, selected from monomers M1 and particularly from diamines of the formula V1, is reacted with at least one amide-forming compound selected from monomers M3, in particular from lactams of aliphatic w-aminocarboxylic acids having 4, 5 or 6 carbon atoms, and mixtures thereof with monomers M2. In this embodiment, the at least one amide-forming compound is used, based on 1 mol of the at least one amino compound, specifically in an amount of more than 3 mol, in particular of more than 6 mol and particularly preferably of more than 12 mol.

In one or more embodiments, the monomers M3 are selected from the lactams of aliphatic ω-(C₄-C₆)-aminocarboxylic acids and mixtures thereof with one or more dicarboxylic acids or amide-forming derivatives thereof. In particular, the at least one monomer M3 is ε-caprolactam. If the reactions according to the above specific embodiment are carried out with a lactam and one or more dicarboxylic acids or amide-forming derivatives thereof, the molar ratio of lactam to dicarboxylic acids or dicarboxylic acid derivatives is generally in the range from 20:1 to 1:10, specifically in the range from 15:1 to 1:5 and in particular in the range from 10:1 to 1:2.

In the two specific embodiments above, the terms monomer M1, diamine of the formula V1, amide-forming derivative of a dicarboxylic acid, monomer M2, monomer M3 and lactam have the meanings defined above and in particular the meanings specified as being preferred.

The reactions according to the two above-mentioned specific embodiments are carried out with two or more different, in particular two different, amino compounds having 2 primary amino groups. In these cases, the second and all further amino compounds having 2 primary amino groups are selected from monomers M1. In this connection, preference is given in particular to those monomers M1 which correspond to the diamines of the formula V1 where the radical A is preferably selected from C₂-C₈-alkanediyl, such as 1,4-butanediyl, 1,5-heptanediyl, 1,6-hexanediyl or 1,7-heptanediyl, [(C₂-C₆)-alkanediyl-NH]ₒ—(C₃-C₆)-alkanediyl with alkanediyl units selected independently of one another and o=1, 2 or 3, such as N,N′-bis(3-aminopropyl)ethylenediamine, and (C₂-C₆)-alkanediyl-O—[(C₂-C₆)-alkanediyl-O]ᵣ—(C₂-C₆)-alkanediyl where r=1, 2, 3 or 4, such as 4,9-dioxadodecane-1,12-diamine or 4,7,10-trioxatridecane-1,13-diamine. If the reactions are carried out with two different amino compounds having 2 primary amino groups, the molar ratio of the two amino compounds is generally in the range from 20:1 to 1:1, preferably in the range from 15:1 to 1:1 and in particular in the range from 10:1 to 1:1. If the reactions are carried out with more than two amino groups having 2 primary amino groups, the molar ratio of one amino compound relative to the sum of all of the other amino compounds is generally in the range from 1:30 to 1:1, preferably in the range from 1:20 to 1:1 and in particular in the range from 1:15 to 1:2.

In the reactions according to the two above-mentioned specific embodiments, the amino compounds with 2 primary amino groups are selected from 1,6-diaminohexane and mixtures thereof with at least one further diamine V1 different therefrom. The amino compounds with 2 primary amino groups are particularly selected from 1,6-diaminohexane and mixtures thereof with a further diamine V1 different therefrom.

Moreover, the reactions according to the two above-mentioned specific embodiments can be carried out in the presence of at least one triamine with three primary amino groups. In one or more embodiments, the triamines are selected from compounds of the formulae V3 and V4,

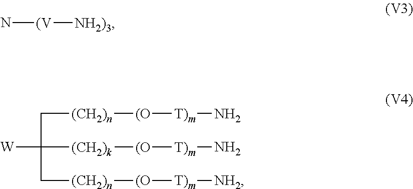

in which V is a bivalent aliphatic radical and is in particular C₂-C₁₀-alkanediyl, W is hydrogen or an aliphatic radical and is in particular hydrogen or C₁-C₆-alkyl, T is C₂-C₄-alkanediyl, in particular 1,2-ethanediyl, 1,2-propanediyl, 1,3-propanediyl, 1,2-butanediyl, 1,3-butanediyl, 1,4-butanediyl or 2-methyl-1,2-propanediyl and is specifically 1,2-ethanediyl or 1,2-propanediyl, n and k, independently of one another, are 0, 1, 2, 3 or 4 and are in particular 0 or 1, and m is an integer in the range from 1 to 20 and in particular from 3 to 8. If the reactions are carried out in the presence of at least one triamine with three primary amino groups, the molar ratio of the at least one triamine to the at least one amino compound having two primary amino groups is generally in the range from 1:1 to 1:50, specifically in the range from 1:3 to 1:30 and in particular in the range from 1:10 to 1:25. In one or more embodiments, if at least one triamine having three primary amino groups is used in the reactions according to the invention, only one such triamine is used in combination with one or two, in particular one, amino compound having 2 primary amino groups.

The reactions to give the oligoamides of the present invention can take place analogously to known prior art processes by polycondensation of the bivalent monomers, as described, for example, in “Technische Polymere [Technical polymers], chapter 4: Polyamide [Polyamides]”, ed. L. Bottenbruch and R. Binsack, 1998, Hanser (Munich, Vienna). The reaction conditions naturally depend on the type and functionality of the monomers used.

A suitable process for the preparation of the oligoamides according to the invention is thermal polycondensation. In this process, a monomer mixture, which, in one or more embodiments, comprises dicarboxylic acids and diamines, is reacted at comparatively high temperatures, for example in the range from 180° C. to 350° C., in particular from 220° C. to 300° C. and as a rule increased pressures of from 0.8 bar to 30 bar, in particular 5 bar to 20 bar. The reaction can take place without a diluent, in solution or in suspension.

In one or more embodiments, the reaction is carried out in a solvent suitable for the reaction. In the case of the dicarboxylic acids and diamines, water in particular is suitable as solvent. Here, the water fraction in the reaction mixture is usually 20 mass percent to 80 mass percent, in particular 30 mass percent to 60 mass percent with regard to the initial weight of monomer. If a high water fraction is used for the reaction, which can optionally also be above the aforementioned upper range limits, the oligoamides can be obtained present in aqueous dispersion. If desired, such a primary dispersion can be used directly for producing detergents, washing additive compositions, laundry pretreatment compositions or cleaners.

In one or more embodiments, if the monomer mixture comprises lactams and diamines, the oligoamides according to the invention are produced by means of hydrolytic polycondensation, which is likewise preferably carried out in a temperature range from 180° C. to 350° C., in particular from 220° C. to 300° C. and at pressures of 0.8 bar to 30 bar, in particular 5 bar to 20 bar. In this connection, a comparatively small water fraction of 1 mass percent to 30 mass percent, in particular 3 mass percent to 12 mass percent with regard to the initial weight of the monomer is used, in which the lactam is generally present in dispersed form. Alternatively, monomer mixtures which comprise lactams can be converted to the oligoamides according to the invention by alkaline polymerization with the exclusion of water at generally somewhat lower temperatures.

In one or more embodiments, if monomer combinations are used which comprise amide-forming derivatives of diamines or dicarboxylic acids, such as, for example, diisocyanates and dicarboxylic acids, diamines and dicarbonyl dichlorides or diamines and dinitriles, the polycondensation reaction is carried out in solution and optionally in the presence of a catalyst.

If the products prepared in this way are not intended to be further processed directly to give detergents, washing additive compositions, laundry pretreatment compositions or cleaners, the work-up of the crude products obtained in the aforementioned processes takes place usually by drying and subsequent grinding to give a powder or by dissolving, preferably in a moderately polar organic solvent, in particular selected from phenols, cresols and benzyl alcohol, subsequent precipitation by very polar solvents, such as methanol, water or acetone, and subsequent dispersion in water. The oligoamides obtained in this way in the form of a powder or an aqueous dispersion can be used for producing detergents, washing additive compositions, laundry pretreatment compositions or cleaners.

For the purposes of the present invention, the oligoamides are water-soluble, water-dispersible or water-insoluble, with the water-insoluble ones being preferred for use in detergents, washing additive compositions, laundry pretreatment compositions or cleaners. The joint use of two or more oligoamides of this type is also possible.

In one or more embodiments, the oligoamide particles have particle sizes in the range from 1 nm to 500 μm, in particular 5 nm to 100 μm. Their average particle size (number-average) is in the range from 5 nm to 100 μm, in particular 1 μm to 50 μm.

The weight-average particle diameter of the oligoamides of the invention present in aqueous dispersion can be determined by means of methods known from the prior art, such as, for example, sieve analysis or light scattering, and is typically in the range from 0.01 μm to 500 μm, specifically in the range from 0.1 μm to 250 μm and in particular in the range from 0.2 μm to 200 μm.

The oligoamides present in solid form can be converted, if desired, to particle form by means of customary extrusion or grinding processes. The particles can be round in shape or have any desired irregular shape. In this connection, it is possible for the shapes of the particles to deviate from the spherical form such that they have, in their longest spatial dimension, a diameter which is significantly larger, optionally larger by up to several orders of magnitude, than that of their shortest spatial dimension and particularly preferably than those of the two other spatial dimensions; in the case of the last-mentioned embodiment, one usually speaks of fibers. The particles can also be further processed in dispersion form, especially for use in liquid compositions.

In the course of a manual or machine washing or cleaning process, the amino-end-group-rich oligoamides of this invention can be added separately to the washing solution, for example as a constituent of a washing additive composition. In one or more embodiments, the amino-end-group-rich oligoamides of this invention are brought into contact with the textile as a constituent of a pretreatment composition in a step which precedes the actual washing process, or are furthermore preferably introduced into the washing or cleaning solution as a constituent of a detergent or cleaner. The invention provides the use of oligoamides, which have at least 250 μmol/g of basic amino groups, as additives in textile detergent compositions. In this connection, the oligoamides used according to the invention have the aforementioned properties, in particular the properties specified as being preferred or particularly preferred. In one or more embodiments, their use in a laundry pretreatment step is also possible, in which case the oligoamide-containing pretreatment composition is then not washed out, but remains on the textile then to be washed and passes together with this into the wash liquor.

The invention therefore further provides a color-protecting detergent, washing additive composition, laundry pretreatment composition or cleaner, comprising a color transfer inhibitor in the form of one of the above-described oligoamides, which has at least 250 μmol/g of basic amino groups, as well as customary ingredients compatible with this constituent.

In one or more embodiments, a composition according to the invention comprises 0.05% by weight to 20% by weight, in particular 0.1% by weight to 5% by weight, of the oligoamide.

The oligoamides mentioned make a contribution to both aspects of color constancy discussed at the start, i.e. they reduce both discoloration and fading, although the effect of preventing staining, in particular during the washing of white textiles, is most pronounced. The invention therefore further provides the use of oligoamides, which have at least 400 μmol/g of basic amino groups, for avoiding the change in the color impression of textiles during their washing in particular surfactant-containing aqueous solutions. Change in the color impression is in no way to be understood as meaning the difference between soiled textile and clean textile, but the color difference between clean textile before and after the washing process.

The invention further provides a method for washing colored textiles in surfactant-containing aqueous solutions, which comprises using a surfactant-containing aqueous solution which comprises one of the above-described oligoamides, which has at least 250 μmol/g of basic amino groups. In such a method, it is possible to also wash white or noncolored textiles together with the colored textile without the white or uncolored textile becoming stained. The concentration of the oligoamide in the surfactant-containing aqueous solution here is preferably 0.025 g/l to 5 g/l, in particular 0.2 g/l to 2.5 g/l.

Besides the specified color-transfer-inhibiting active ingredient, i.e. the oligoamide, a composition according to the invention can if desired also additionally comprise a known color transfer inhibitor, preferably in amounts of from 0.01% by weight to 5% by weight, in particular 0.1% by weight to 1% by weight, which, in a specific embodiment of the invention, is a polymer of vinylpyrrolidone, vinylimidazole, vinylpyridine N-oxide or a copolymer of these. It is possible to use either polyvinylpyrrolidones with molecular weights of from 15 000 to 50 000 or polyvinylpyrrolidones with molecular weights above 1 000 000, in particular from 1 500 000 to 4 000 000, N-vinylimidazole/N-vinylpyrrolidone copolymers, polyvinyloxazolidones, polyamine N-oxide polymers, polyvinyl alcohols and copolymers based on acrylamidoalkenylsulfonic acids. However, it is also possible to use enzymatic systems comprising a peroxidase and hydrogen peroxide or a substance which produces hydrogen peroxide in water. The addition of a mediator compound for the peroxidase, for example an acetosyringone, a phenol derivative or a phenothiazine or phenoxazine, is specific in this case, where also additionally aforementioned conventional polymeric color transfer inhibitor active ingredients can be used. Polyvinylpyrrolidone preferably has an average molar mass in the range from 10 000 g/mol to 60 000 g/mol, in particular in the range from 25 000 g/mol to 50 000 g/mol for use in compositions according to the invention. Among the copolymers, preference is given to those of vinylpyrrolidone and vinylimidazole in the molar ratio 5:1 to 1:1 with an average molar mass in the range from 5000 g/mol to 50 000 g/mol, in particular 10 000 g/mol to 20 000 g/mol.

The compositions according to the invention, which may be solid or liquid and can be present in particular as pulverulent solids, in post-compacted particulate form, as homogeneous solutions or suspensions, can in principle comprise all known ingredients that are customary in compositions of this type besides the active ingredient used according to the invention. The compositions according to the invention can comprise in particular builder substances, surface-active surfactants, bleaches based on organic and/or inorganic peroxygen compounds, bleach activators, water-miscible organic solvents, enzymes, sequestrants, electrolytes, pH regulators and further auxiliaries, such as optical brighteners, graying inhibitors, foam regulators, and also dyes and fragrances. In this connection, according to the invention, it is also possible to apply the oligoamide to a water-insoluble cloth, or to incorporate it, optionally with further customary ingredients, into a bag made of water-insoluble but water-permeable material, or to produce a cloth, or another shaped body such as, for example, a sphere or a cube, from the polymer, in particular if it is present in fiber form, and to use it in this form as an additive or as a constituent of an additive in the washing or cleaning process. Alternatively to the last-mentioned embodiment, the oligoamide or a composition comprising this can be introduced into the washing or cleaning process in portions packaged into a water-soluble material, for example a polyvinyl alcohol film.

The compositions according to the invention can comprise one or more surfactants, with in particular anionic surfactants, nonionic surfactants and mixtures thereof, but also cationic, zwitterionic and amphoteric surfactants being contemplated.

Suitable nonionic surfactants are in particular alkyl glycosides and ethoxylation and/or propoxylation products of alkyl glycosides or linear or branched alcohols having in each case 12 to 18 carbon atoms in the alkyl moiety and 3 to 20, preferably 4 to 10, alkyl ether groups. It is also possible to use corresponding ethoxylation and/or propoxylation products of N-alkylamines, vicinal diols, fatty acid esters and fatty acid amides which correspond to the specified long-chain alcohol derivatives as regards the alkyl moiety, and also of alkylphenols having 5 to 12 carbon atoms in the alkyl radical.

In one or more embodiments, the nonionic surfactants used are alkoxylated, advantageously ethoxylated, in particular primary alcohols having preferably 8 to 18 carbon atoms and on average 1 to 12 mol of ethylene oxide (EO) per mol of alcohol in which the alcohol radical can be linear or preferably methyl branched in the 2 position, or can comprise linear and methyl-branched radicals in a mixture, as are usually present in oxoalcohol radicals. In particular, however, alcohol ethoxylates with linear radicals from alcohols of native origin having 12 to 18 carbon atoms, e.g. from coconut alcohol, palm alcohol, tallow fatty alcohol or oleyl alcohol, and on average 2 to 8 EO per mole of alcohol are specific. The specific ethoxylated alcohols include, for example, C₁₂-C₁₄-alcohols with 3 EO or 4 EO, C₉-C₁₁-alcohols with 7 EO, C₁₃-C₁₅-alcohols with 3 EO, 5 EO, 7 EO or 8 EO, C₁₂-C₁₈-alcohols with 3 EO, 5 EO or 7 EO and mixtures of these, such as mixtures of C₁₂-C₁₄-alcohol with 3 EO and C₁₂-C₁₈-alcohol with 7 EO. The stated degrees of ethoxylation are statistical average values which may be an integer or a fraction for a specific product. Specific alcohol ethoxylates have a narrowed homolog distribution (narrow range ethoxylates, NRE). In addition to these nonionic surfactants, it is also possible to use fatty alcohols with more than 12 EO. Examples thereof are (tallow) fatty alcohols with 14 EO, 16 EO, 20 EO, 25 EO, 30 EO or 40 EO. Particularly in compositions for use in machine processes, extremely low-foam compounds are usually used. These include preferably C₁₂-C₁₈-alkyl polyethylene glycol polypropylene glycol ethers having in each case up to 8 mol of ethylene oxide and propylene oxide units in the molecule. However, it is also possible to use other known low-foam nonionic surfactants, such as, for example, C₁₂-C₁₈-alkylpolyethylene glycol polybutylene glycol ethers having in each case up to 8 mol of ethylene oxide and butylene oxide units in the molecule, and also terminally capped alkyl polyalkylene glycol mixed ethers. Particular preference is also given to the alkoxylated alcohols containing hydroxyl groups, as are described in the European patent application EP 0 300 305, so-called hydroxy mixed ethers. The nonionic surfactants also include alkyl glycosides of the general formula RO(G)ₓ, in which R is a primary straight-chain or methyl-branched, in particular 2-methyl-branched aliphatic radical having 8 to 22, preferably 12 to 18, carbon atoms and G is a glycose unit having 5 or 6 carbon atoms, preferably glucose. The degree of oligomerization x, which indicates the distribution of monoglycosides and oligoglycosides, is any desired number—which, being a parameter to be determined analytically, can also assume fractional values—between 1 and 10; preferably, x is 1.2 to 1.4. Likewise of suitability are polyhydroxy fatty acid amides of the formula given below,

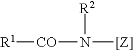

in which in R¹CO is an aliphatic acyl radical having 6 to 22 carbon atoms, R² is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups.

In one or more embodiments, the polyhydroxy fatty acid amides are derived from reducing sugars having 5 or 6 carbon atoms, in particular from glucose. The group of polyhydroxy fatty acid amides also includes compounds of the formula given below,

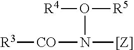

in which R³ is a linear or branched alkyl or alkenyl radical having 7 to 12 carbon atoms, R⁴ is a linear, branched or cyclic alkylene radical or an arylene radical having 2 to 8 carbon atoms and R⁵ is a linear, branched or cyclic alkyl radical or an aryl radical or an oxyalkyl radical having 1 to 8 carbon atoms, with C₁-C₄-alkyl or phenyl radicals being preferred, and [Z] is a linear polyhydroxyalkyl radical, the alkyl chain of which is substituted with at least two hydroxyl groups, or alkoxylated, preferably ethoxylated or propoxylated derivatives of this radical. [Z] is also obtained here preferably by reductive amination of a sugar such as glucose, fructose, maltose, lactose, galactose, mannose or xylose. The N-alkoxy- or N-aryloxy-substituted compounds can then be converted to the desired polyhydroxy fatty acid amides for example by reaction with fatty acid methyl esters in the presence of an alkoxide as catalyst. A further class of used nonionic surfactants, which are used either as the sole nonionic surfactant or in combination with other nonionic surfactants, in particular together with alkoxylated fatty alcohols and/or alkyl glycosides, are alkoxylated, preferably ethoxylated or ethoxylated and propoxylated fatty acid alkyl esters, preferably having 1 to 4 carbon atoms in the alkyl chain, in particular fatty acid methyl esters. Nonionic surfactants of the amine oxide type, for example N-cocoalkyl-N,N-dimethylamine oxide and N-tallowalkyl-N,N-dihydroxyethylamine oxide, and of the fatty acid alkanolamide type may also be suitable. The amount of these nonionic surfactants is preferably not more than that of the ethoxylated fatty alcohols, in particular not more than half thereof. Suitable further surfactants are so-called Gemini surfactants. These are generally understood as meaning those compounds which have two hydrophilic groups per molecule. These groups are generally separated from one another by a so-called “spacer”. This spacer is generally a carbon chain which should be long enough that the hydrophilic groups have a sufficient distance to be able to act independently of one another. Surfactants of this type are generally characterized by an unusually low critical micelle concentration and the ability to reduce the surface tension of water considerably. In exceptional cases, the expression Gemini surfactants is not only understood as meaning “dimeric” surfactants of this type, but also correspondingly “trimeric” surfactants. Suitable Gemini surfactants are, for example, sulfated hydroxy mixed ethers or dimer alcohol bis- and trimer alcohol tris-sulfates and -ether sulfates. Terminally capped dimeric and trimer mixed ethers are characterized in particular by their bi- and multifunctionality. For example, the specified terminally capped surfactants have good wetting properties and are low-foam, meaning that they are suitable in particular for use in machine washing or cleaning processes. However, it is also possible to use Gemini polyhydroxy fatty acid amides or poly-polyhydroxy fatty acid amides. Also of suitability are the sulfuric acid monoesters of the straight-chain or branched C₇-C₂₁-alcohols ethoxylated with 1 to 6 mol of ethylene oxide, such as 2-methyl-branched C₉-C₁₁-alcohols with, on average, 3.5 mol of ethylene oxide (EO) or C₁₂-C₁₈-fatty alcohols with 1 to 4 EO. The specific anionic surfactants also include the salts of alkylsulfosuccinic acid, which are also referred to as sulfosuccinates or as sulfosuccinic acid esters, and the monoesters and/or diesters of sulfosuccinic acid with alcohols, preferably fatty alcohols and in particular ethoxylated fatty alcohols. Specific sulfosuccinates comprise C₈- to C₁₈-fatty alcohol radicals or mixtures of these. Particularly specific sulfosuccinates comprise a fatty alcohol radical which is derived from ethoxylated fatty alcohols which, viewed per se, are nonionic surfactants. In this connection, sulfosuccinates whose fatty alcohol radicals are derived from ethoxylated fatty alcohols with a narrowed homolog distribution are in turn particularly specific. It is also likewise possible to use alk(en)ylsuccinic acid having preferably 8 to 18 carbon atoms in the alk(en)yl chain or salts thereof. Suitable further anionic surfactants are fatty acid derivatives of amino acids, for example of N-methyltaurine (taurides) and/or of N-methylglycine (sarcosides). Particular preference is given here to the sarcosides or the sarcosinates and here in particular sarcosinates of higher and optionally mono- or polyunsaturated fatty acids such as oleyl sarcosinate. Suitable further anionic surfactants are in particular soaps. Of suitability in particular are saturated fatty acid soaps, such as the salts of lauric acid, myristic acid, palmitic acid, stearic acid, hydrogenated erucic acid and behenic acid, and in particular soap mixtures derived from natural fatty acids, for example coconut, palm kernel or tallow fatty acids. The known alkenylsuccinic acid salts can also be used together with these soaps or as a replacement for soaps.

The anionic surfactants, including the soaps, can be present in the form of their sodium, potassium or ammonium salts and also as soluble salts or organic bases, such as mono-, di- or triethanolamine. In one or more embodiments, the anionic surfactants are present in the form of their sodium or potassium salts, in particular in the form of the sodium salts.

Suitable cationic surfactants are, for example, mono- and di-(C₇-C₂₅-alkyl)dimethyl-ammonium compounds and ester quats, in particular quaternary esterified mono-, di- and trialkanolamines which have been esterified with C₈-C₂₂-carboxylic acids.

Suitable amphoteric surfactants are, for example, alkylbetaines, alkylamidobetaines, aminopropionates, aminoglycinates and amphoteric imidazolium compounds.

Surfactants are present in detergents according to the invention in quantitative fractions of preferably 5% by weight to 50% by weight, in particular from 8% by weight to 30% by weight.

In one or more embodiments, a composition according to the invention comprises at least one water-soluble and/or water-insoluble, organic and/or inorganic builder. Water-soluble organic builder substances include polycarboxylic acids, in particular citric acid and sugar acids, monomeric and polymeric aminopolycarboxylic acids, in particular methylglycinediacetic acid, nitrilotriacetic acid and ethylenediaminetetraacetic acid, and also polyaspartic acid, polyphosphonic acids, in particular aminotris(methylenephosphoric acid), ethylenediaminetetrakis(methylenephosphonic acid) and 1-hydroxyethane-1,1-diphosphonic acid, polymeric hydroxy compounds such as dextrin, and polymeric (poly)carboxylic acids, in particular the polycarboxylates accessible by oxidation of polysaccharides or dextrins, polymeric acrylic acids, methacrylic acids, maleic acids and mixed polymers of these, which can also comprise small fractions of polymerizable substances without carboxylic acid functionality in copolymerized form. The relative molecular mass of the homopolymers of unsaturated carboxylic acids is generally between 3000 and 200 000, that of the copolymers is between 2000 and 200 000, preferably 30 000 to 120 000, in each case based on free acid. A particularly specific acrylic acid-maleic acid copolymer has a relative molecular mass of 30 000 to 100 000. Standard commercial products are, for example, Sokalan® CP 5, CP 10 and PA 30 from BASF. Suitable, although less specific compounds of this class are copolymers of acrylic acid or methacrylic acid with vinyl ethers, such as vinyl methyl ethers, vinyl esters, ethylene, propylene and styrene, in which the acid fraction is at least 50% by weight. Water-soluble organic builder substances which can be used are also terpolymers which comprise, as monomers, two unsaturated acids and/or salts thereof, and also, as a third monomer, vinyl alcohol and/or an esterified vinyl alcohol or a carbohydrate, where the first acidic monomer is derived from a monoethylenically unsaturated C₃-C₈-carboxylic acid and preferably from a C₃-C₄-monocarboxylic acid, in particular from (meth)acrylic acid, and the second acidic monomer is a derivative of a C₄-C₈-dicarboxylic acid, with maleic acid being particularly specific, and/or a derivative of an allylsulfonic acid which is substituted in the 2 position with an alkyl or aryl radical. The organic builder substances can be used in particular for producing liquid compositions, in the form of aqueous solutions, preferably in the form of 30- to 50-percent by weight aqueous solutions. All of the specified acids are generally used in the form of their water-soluble salts, in particular their alkali metal salts.

Organic builder substances of this type can be present in the compositions if desired in amounts up to 40% by weight, in particular up to 25% by weight and specifically from 1% by weight to 8% by weight. Amounts close to the specified upper limit are preferably used in pasty or liquid, in particular water-containing, compositions according to the invention.

Suitable water-soluble inorganic builder materials are in particular alkali metal silicates, alkali metal carbonates and alkali metal phosphates, which can be present in the form of their alkaline, neutral or acidic sodium or potassium salts. Examples thereof are trisodium phosphate, tetrasodium diphosphate, disodium dihydrogendiphosphate, pentasodium triphosphate, so-called sodium hexametaphosphate, oligomeric trisodium phosphate with degrees of oligomerization of 5 to 1000, in particular 5 to 50, and also the corresponding potassium salts or mixtures of sodium and potassium salts. Water-insoluble, water-dispersible inorganic builder materials which can be used are in particular crystalline or amorphous alkali metal aluminosilicates, in amounts of up to 50% by weight, preferably not more than 40% by weight and in liquid compositions in particular from 1% by weight to 5% by weight. Among these, the crystalline sodium aluminosilicates in detergent grade, in particular zeolite A, P and optionally X, alone or in mixtures, for example in the form of a co-crystallizate of the zeolites A and X (Vegobond® AX, a commercial product from Condea Augusta S.p.A.), are specific. Amounts close to the specified upper limit are preferably used in solid, particulate compositions. Suitable aluminosilicates have in particular no particles with a particle size above 30 μm and consist preferably to at least 80% by weight of particles with a size below 10 μm. Their calcium binding capacity, which can be determined in accordance with the details in the German patent specification DE 24 12 837, is generally in the range from 100 to 200 mg of CaO per gram.

Suitable substitutes or partial substitutes for the specified aluminosilicate are crystalline alkali metal silicates, which may be present on their own in a mixture with amorphous silicates. The alkali metal silicates that can be used as builders in the compositions according to the invention preferably have a molar ratio of alkali metal oxide to SiO₂ below 0.95, in particular of 1:1.1 to 1:12, and can be present in amorphous or crystalline form. Specific alkali metal silicates are the sodium silicates, in particular the amorphous sodium silicates, with a molar ratio Na₂O:SiO₂ of 1:2 to 1:2.8. The crystalline silicates used, which may be present on their own or in a mixture with amorphous silicates, are preferably crystalline sheet silicates of the general formula Na₂SiₓO₂ₓ₊₁.y H₂O, in which x, the so-called modulus, is a number from 1.9 to 22, in particular 1.9 to 4 and y is a number from 0 to 33 and specific values for x are 2, 3 or 4. Specific crystalline sheet silicates are those in which x in the specified general formula assumes the values 2 or 3. In particular, both β- and δ-sodium disilicates (Na₂Si₂O₅.y H₂O) are specific. Also virtually anhydrous crystalline alkali metal silicates produced from amorphous alkali metal silicates and of the aforementioned general formula in which x is a number from 1.9 to 2.1 can be used in compositions according to the invention. In a further specific embodiment of compositions according to the invention, a crystalline sodium sheet silicate with a modulus of 2 to 3 is used, as can be produced from sand and soda. Crystalline sodium silicates with a modulus in the range from 1.9 to 3.5 are used in a further specific embodiment of compositions according to the invention. Crystalline sheet-like silicates of the formula (I) given above are sold by Clariant GmbH under the trade name Na-SKS, e.g. Na-SKS-1 (Na₂Si₂₂O₄₅.xH₂O, kenyaite), Na-SKS-2 (Na₂Si₁₄O₂₉.xH₂O, magadiite), Na-SKS-3 (Na₂Si₈O₁₇.xH₂O) or Na-SKS-4 (Na₂Si₄O₉.xH₂O, makatite). Of these, in particular Na-SKS-5 (α-Na₂Si₂O₅), Na-SKS-7 (β-Na₂Si₂O₅, natrosilite), Na-SKS-9 (NaHSi₂O₅.3H₂O), Na-SKS-10 (NaHSi₂O₅.3H₂O, kanemite), Na-SKS-11 (t-Na₂Si₂O₅) and Na-SKS-13 (NaHSi₂O₅), but in particular Na-SKS-6 (δ-Na₂Si₂O₅) are suitable. In one specific embodiment of compositions according to the invention, a granular compound of crystalline sheet silicate and citrate, of crystalline sheet silicate and aforementioned (co)polymeric polycarboxylic acid, or of alkali metal silicate and alkali metal carbonate is used, as is commercially available, for example, under the name Nabion® 15.

Builder substances are present in the compositions according to the invention preferably in amounts up to 75% by weight, in particular 5% by weight to 50% by weight.

Peroxygen compounds suitable for use in compositions according to the invention are in particular organic peracids or peracidic salts of organic acids, such as phthalimidopercaproic acid, perbenzoic acid or salts of diperdodecanedioic acid, hydrogen peroxide and inorganic salts which release hydrogen peroxide under the washing conditions, which include perborate, percarbonate, persilicate and/or persulfate such as caroat. If solid peroxygen compounds are to be used, these can be used in the form of powders or granules, which may also be coated in a manner known in principle. If a composition according to the invention comprises peroxygen compounds, these are present in amounts of preferably up to 50% by weight, in particular from 5% by weight to 30% by weight. The addition of small amounts of known bleach stabilizers such as, for example, of phosphonates, borates or metaborates and metasilicates, and also magnesium salts such as magnesium sulfate may be appropriate.

Bleach activators which can be used are compounds which produce, under perhydrolysis conditions, aliphatic peroxocarboxylic acids having preferably 1 to 10 carbon atoms, in particular 2 to 4 carbon atoms, and/or optionally substituted perbenzoic acid. Substances which carry O- and/or N-acyl groups of the specified number of carbon atoms and/or optionally substituted benzoyl groups are suitable. Preference is given to polyacylated alkylenediamines, in particular tetra-acetylethylenediamine (TAED), acylated triazine derivates, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxy-benzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and enol esters, and also aetylated sorbitol and mannitol or their described mixtures (SORMAN), acylated sugar derivatives, in particular pentaacetylglucose (PAG), pentaacetylfructose, tetraacetylxylose and octaacetyllactose, and also acetylated, optionally N-alkylated glucamine and gluconolactone, and/or N-acylated lactams, for example N-benzoylcaprolactam. The hydrophilically substituted acylacetals and the acyllactams are likewise preferably used. Combinations of conventional bleach activators can also be used. Bleach activators of this type can be present, especially in the case of the presence of aforementioned hydrogen peroxide-producing bleaches, in the customary quantitative range, preferably in amounts of 0.5% by weight to 10% by weight, in particular 1% by weight to 8% by weight, based on the total composition, but are omitted entirely when using percarboxylic acid as the sole bleach.

In addition to the conventional bleach activators, or instead of them, it is also possible for sulfonimines and/or bleach-boosting transition metal salts or transition metal complexes to be present as so-called bleach catalysts.

Suitable enzymes which can be used in the compositions are those from the class of amylases, proteases, lipases, cutinases, pullulanases, hemicellulases, cellulases, oxidases, laccases and peroxidases, and mixtures thereof. Enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus are particularly suitable. The enzymes can be adsorbed to carrier substances and/or embedded in coating substances in order to protect them against premature inactivation. They are present in the detergents or cleaners according to the invention preferably in amounts up to 5% by weight, in particular from 0.2% by weight to 4% by weight. If the composition according to the invention comprises protease, it preferably has a proteolytic activity in the range from about 100 PU/g to about 10 000 PU/g, in particular 300 PU/g to 8000 PU/g. If two or more enzymes are to be used in the composition according to the invention, this can be carried out by incorporating the two or more separate, or separately formulated (in a known manner) enzymes or by two or more enzymes formulated together in one set of granules.

The organic solvents which can be used alongside water in the compositions according to the invention, especially if they are present in liquid or pasty form, include alcohols having 1 to 4 carbon atoms, in particular methanol, ethanol, isopropanol and tert-butanol, diols having 2 to 4 carbon atoms, in particular ethylene glycol and propylene glycol, and also mixtures thereof and the ethers which can be derived from the specified compound classes. Water-miscible solvents of this type are present in the compositions according to the invention preferably in amounts not exceeding 30% by weight, in particular from 6% by weight to 20% by weight.

To establish a desired pH which does not arise by itself as a result of mixing the other components, the compositions according to the invention can comprise system- and environment-compatible acids, in particular citric acid, acetic acid, tartaric acid, malic acid, lactic acid, glycolic acid, succinic acid, glutaric acid and/or adipic acid, but also mineral acids, in particular sulfuric acid, or bases, in particular ammonium or alkali metal hydroxides. pH regulators of this type are present in the compositions according to the invention in amounts of preferably not more than 20% by weight, in particular from 1.2% by weight to 17% by weight.

Graying inhibitors have the task of keeping the dirt detached from the textile fiber suspending in the liquor. Of suitability for this are water-soluble colloids, mostly organic in nature, for example starch, size, gelatin, salts of ethercarboxylic acids or ethersulfonic acids of starch or of cellulose or salts of acidic sulfuric acid esters of cellulose or of starch. Water-soluble polyamides comprising acidic groups are also suitable for this purpose. Furthermore, it is possible to use starch derivatives other than those mentioned above, for example aldehyde starches. Preference is given to using cellulose ethers, such as carboxymethylcellose (Na salt), methylcellulose, hydroxyalkylcellulose and mixed ethers, such as methylhydroxyethylcellulose, methylhydroxypropylcellulose, methylcarboxymethylcellulose and mixtures thereof, for example in amounts of 0.1 to 5% by weight, based on the compositions.

Textile detergents according to the invention can comprise, as optical brighteners, for example derivatives of diaminostilbenedisulfonic acid or alkali metal salts thereof, although they are preferably free from optical brighteners for use as color detergents. Of suitability are, for example, salts of 4,4′-bis(2-anilino-4-morpholino-1,3,5-triazinyl-6-amino)stilbene-2,2′-disulfonic acid or compounds with the same type of structure which carry a diethanolamino group, a methylamino group, an anilino group or a 2-methoxyethylamino group instead of the morpholino group. Furthermore, brighteners of the substituted diphenylstyryl type may be present, for example the alkali metal salts of 4,4′-bis(2-sulfostyryl)diphenyl, 4,4′-bis(4-chloro-3-sulfostyryl)diphenyl, or 4-(4-chloro-styryl)-4′-(2-sulfostyryl)diphenyl. Mixtures of the aforementioned optical brighteners can also be used.

Particularly when used in machine processes, it may be advantageous to add customary foam inhibitors to the compositions. Suitable foam inhibitors are, for example, soaps of natural or synthetic origin which have a high fraction of C₁₈-C₂₄-fatty acids. Suitable non-surfactant-like foam inhibitors are, for example, organopolysiloxanes and mixtures thereof with microfine, optionally silanized silica, and also paraffins, waxes, microcrystalline waxes and mixtures thereof with silanized silica or bis-fatty acid alkylenediamides. Mixtures of different foam inhibitors are also advantageously used, for example those of silicones, paraffins or waxes. Preferably, the foam inhibitors, in particular silicone- and/or paraffin-containing foam inhibitors, are bonded to a granular, water-soluble or dispersible carrier substance. In this connection, particular preference is given to mixtures of paraffins and bistearylethylenediamide.

The production of solid compositions according to the invention presents no difficulties and can take place in a known manner, for example by spray drying or granulation, in which case enzymes and any other thermally sensitive ingredients, such as, for example, bleach, are optionally added separately later on. To produce compositions according to the invention with an increased bulk density, in particular in the range from 650 g/l to 950 g/l, a process having an extrusion step is preferred.

To produce compositions according to the invention in tablet form, which can be single-phase or multiphase, single-colored or multicolored and in particular can consist of one layer or of two or more, in particular of two, layers, the procedure preferably involves mixing together all of the constituents—optionally in each case of one layer—in a mixer and compressing the mixture using conventional tableting presses, for example eccentric presses or rotary presses, using pressing forces in the range from about 50 to 100 kN, preferably at 60 to 70 kN. Particularly in the case of multilayered tablets, it may be advantageous if at least one layer is precompressed. This is preferably carried out at pressing forces between 5 and 20 kN, in particular at 10 to 15 kN. This gives, without problem, fracture-resistant tablets which nevertheless have sufficiently rapid solubility under application conditions and have fracture resistances and flexural strengths of normally 100 to 200 N, but preferably above 150 N. Preferably, a tablet produced in this way has a weight of 10 g to 50 g, in particular of 15 g to 40 g. The three-dimensional shape of the tablets is arbitrary and can be round, oval or cornered, with intermediate shapes also being possible. Corners and edges are advantageously rounded. Round tablets preferably have a diameter of 30 mm to 40 mm. In particular, the size of tablets with corners or a square shape, which are introduced predominantly via the dosing device for example of the dishwasher, is dependent on the geometry and the volume of this dosing device. Variants preferred by way of example have a basic area of (20 to 30 mm)×(34 to 40 mm), in particular of 26×36 mm or of 24×38 mm.

Liquid or pasty compositions according to the invention in the form of solutions comprising customary solvents, in particular water, are generally produced by simply mixing the ingredients, which can be added to an automatic mixer without dilution or in the form of a solution.

### EXAMPLES

### Example 1

### Methods for Ascertaining Analytical Characteristic Data

### a) Determining the Fraction of Basic Amino Groups in the Oligoamides (AEG)

The precisely weighed-in sample was dissolved in a phenol/methanol mixture and potentiometrically titrated with hydrochloric acid solution (0.02 N). The consumption as far as the point of inflection of the titration curve and a corresponding blank value for the pure solvent were used to calculate the number of titratable amino groups.

### b) Determination of the Viscosity Number (VN):

The determination was carried out on 0.5% by weight polymer solutions in concentrated sulfuric acid (96% strength) in accordance with DIN 53 727 at 25° C.

### c) Determination of the Fraction of Carboxyl End Groups in the Polyamides (CEG)

Depending on the amount of carboxyl end groups to be expected, samples of 0.8 to 2.0 g of polyamide were dissolved in each case in 25 ml of benzyl alcohol under reflux. After the samples had dissolved completely, in each case 0.5 ml of cresol-red was added. By means of visual titration with a solution of potassium hydroxide in ethanol (0.5 N), the amount of terminal carboxyl groups was determined, with the color change from yellow to violet serving as the end point determination. To correct the values ascertained, a blank value was determined analogously to the above procedure, except that no polyamide sample was added.

### Example 2

### Preparation of Oligoamides

### a) Comparison Polymer V:

8.30 g of aqueous hexamethylenediamine solution (70% by weight) and 6.06 g of adipic acid were dissolved in 10.0 g of water and heated to 280° C. under 17 bar in a large, thick-walled test tube in a pressurized reactor. The pressure and the temperature were held for 1 hour and the pressure was then reduced to atmospheric pressure over the course of 45 minutes. Under a continuous stream of nitrogen, the after-condensation was then carried out at 280° C. for 2 hours, and the product was removed after cooling, dried in vacuo (100 mbar) at 80° C. and ground.

AEG=43 μmol/g

### b) Polymer A

400.0 g of caprolactam, 28.0 g of aqueous hexamethylenediamine solution (71.4% by weight) and 32.0 g of water were weighed into a pressurized reactor. The reactor was flushed several times with nitrogen, then closed and heated to an external temperature of 270° C. (internal temperature of ca. 260° C.). The reaction was held at an internal temperature of ca. 260° C. and 16 bar for 15 minutes and the pressure was then decompressed to ambient pressure over the course of one hour and then the mixture was after-condensed for 120 minutes with nitrogen stream flushing at an internal temperature of 260° C. Finally, the polymer was discharged from the reactor by applying a nitrogen overpressure, dried after cooling and ground in a laboratory centrifugal mill. The powder particle sizes obtained were between 5 μm and 300 μm, the average particle size was ca. 50 μm (visual assessment in the light microscope).

AEG=770 μmol/g

CEG=10 μmol/g

### c) Polymer B

400.0 g of caprolactam, 84.0 g of aqueous hexamethylenediamine solution (71.4% by weight) and 16.0 g of water were weighed into a pressurized reactor. The reactor was flushed several times with nitrogen, then closed and heated to an external temperature of 270° C. (an internal temperature of ca. 260° C.). The reaction was maintained at an internal temperature of ca. 260° C. and 16 bar for 15 minutes, the pressure was then decompressed to ambient pressure over the course of one hour and then the mixture was after-condensed for 120 minutes with nitrogen stream flushing at an internal temperature of 260° C. Finally, the polymer was discharged from the reactor by applying a nitrogen overpressure, dried after cooling and ground.

The powder particle sizes obtained were between 50 and 1000 μm, the average particle size was ca. 200 μm (visual assessment in the light microscope).

AEG=1700 μmol/g

CEG=10 μmol/g

### d) Polymer C

2.08 g of aqueous hexamethylenediamine solution (70% by weight), 5.04 g of adipic acid and 8.25 g of 4,7,10-trioxatridecane-1,13-diamine were dissolved in 10.0 g of water and heated to 280° C. under 17 bar in a large, thick-walled test tube in a pressurized reactor. The pressure and the temperature were held for 1 hour and the pressure was then reduced to atmospheric pressure over the course of 45 minutes. Under a continuous stream of nitrogen, the after-condensation was then carried out at 280° C. for 2 hours, and the product was removed after cooling, dried in vacuo (100 mbar) at 80° C. and ground.

VN=10 ml/g

AEG=1360 μmol/g

CEG=20 μmol/g

### e) Polymer D

4.98 g of aqueous hexamethylenediamine solution (70% by weight), 6.05 g of adipic acid and 6.46 g of bis(hexamethylene)triamine were dissolved in 10.0 g of water and heated to 280° C. under 17 bar in a large, thick-walled test tube in a pressurized reactor. The pressure and the temperature were held for 1 hour and the pressure was then reduced to atmospheric pressure over the course of 45 minutes. Under a continuous stream of nitrogen, the after-condensation was then carried out at 280° C. for 2 hours, and the product was removed after cooling, dried in vacuo (100 mbar) at 80° C. and ground.

VN=29 ml/g

AEG=3090 μmol/g

CEG=20 μmol/g

### f) Polymer E

6.64 g of aqueous hexamethylenediamine solution (70% by weight), 3.90 g of adipic acid and 4.13 g of diethylenetriamine were dissolved in 10.0 g of water and heated to 280° C. under 17 bar in a large, thick-walled test tube in a pressurized reactor. The pressure and the temperature were held for 1 hour and the pressure was then reduced to atmospheric pressure over the course of 45 minutes. Under a continuous stream of nitrogen, the after-condensation was then carried out at 280° C. for 2 hours, and the product was removed after cooling, dried in vacuo (100 mbar) at 80° C. and ground.

VN=9 ml/g

AEG=4880 μmol/g

CEG=30 μmol/g

### g) Polymer F

6.64 g of aqueous hexamethylenediamine solution (70% by weight), 3.90 g of adipic acid and 8.62 g of bis(hexamethylene)triamine were dissolved in 10.0 g of water and heated to 280° C. under 17 mbar in a large, thick-walled test tube in a pressurized reactor. The pressure and the temperature were held for 1 hour and the pressure was then reduced to atmospheric pressure over the course of 45 minutes. Under a continuous stream of nitrogen, the after-condensation was then carried out at 280° C. for 2 hours, and the product was removed after cooling, dried in vacuo (100 mbar) at 80° C. and ground.

VN=9 ml/g

AEG=7190 μmol/g

CEG=15 μmol/g

### h) Polymer G

90.53 g of caprolactam and 20.63 g of diethylenetriamine were weighed into a pressurized reactor with 160 g of water. The reactor was flushed several times with nitrogen, then closed and heated to an external temperature of 280° C. (an internal temperature of ca. 270° C.). The reaction was maintained at an internal temperature of ca. 270° C. and 16 bar for 15 minutes, and the pressure was then decompressed to ambient pressure over the course of one hour and then the mixture was after-condensed for 120 minutes with nitrogen stream flushing at an internal temperature of 270° C. Finally, the polymer was discharged from the reactor by applying a nitrogen overpressure, dried after cooling and ground.

VN=16 ml/g

AEG=5030 μmol/g

CEG=40 μmol/g

### Example 3

### Color Transfer Inhibition

A color transfer inhibitor-free liquid detergent W1 (5 g/l) was used to produce a wash liquor to which the colored textiles given in the table below were added and with which white textile items (6 cm×16 cm) made of cotton (Krefeld Standard) or polyamide (EMPA 406) were treated at 60° C. for 30 minutes. For comparison, otherwise identical wash liquors which, in addition to the composition W1, comprised one of the oligoamides (V, A or B in each case 5 g/l, D, E, F, or G in each case 2.5 g/l) produced as described above, were tested under the same conditions. The bleeding into the white accompanying textiles was assessed in accordance with DIN EN ISO 105-A04 on a scale from 1 (severe staining) to 5 (no staining). The results are given in the table below.

| | Colored | | + | + | + | + | + | + | + |
|---|---|---|---|---|---|---|---|---|---|
| Material | textile | W1 | V | A | B | D | E | F | G |
| Cotton | 1 g | 4.2 | 4.1 | 4.7 | 4.9 | n.d. | 4.7 | 4.5 | 4.8 |
| | AISE | | | | | | | | |
| | 41-31 | | | | | | | | |
| Polyamide | 0.3 g | 2.0 | 2.4 | 3.9 | 3.9 | 2.9 | 2.9 | 3.7 | 2.5 |
| | EMPA | | | | | | | | |
| | 131 | | | | | | | | |
| Polyamide | 1 g | 3.5 | 3.7 | 3.9 | n.d. | 4.1 | n.d. | 4.5 | n.d. |
| | AISE | | | | | | | | |
| | 41-30 | | | | | | | | |
| Polyamide | 1 g | 2.6 | 2.6 | 3.1 | 4.1 | 3.4 | 3.5 | n.d. | 3.8 |
| | AISE | | | | | | | | |
| | 41-31 | | | | | | | | |

It can be seen that, compared to the detergent without the addition of the oligoamides essential to the invention, the white textiles upon washing with the addition of oligoamide were less stained.

What is claimed is:

1. A detergent, washing additive composition, laundry pretreatment composition or cleaner, comprising a color transfer inhibitor in the form of an oligoamide, the oligoamide having at least 750 μmol/g of basic amino groups, as well as customary ingredients compatible with this constituent, wherein the oligoamide consists essentially of repeating units of formulae Ia and/or Ib and optionally branching units of the formulae II and/or II′, 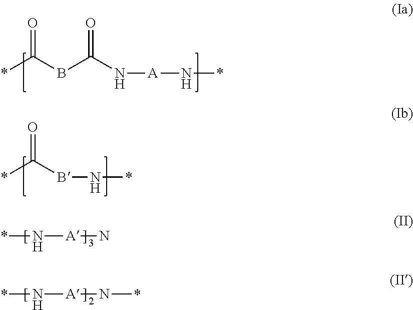
wherein
A is selected from alkanediyl radicals having 2 to 20 carbon atoms, wherein 1, 2, 3, 4 or 5 nonadjacent CH₂ groups can be replaced by a corresponding number of NH groups and/or in which 2 joined together CH₂ groups can be jointly replaced by a C₅-C₇-cycloalkanediyl group, and groups of the formula (A″-O)ₚ-A′, wherein A″ is C₂-C₄-alkanediyl, and p is an integer in the range from 1 to 20, wherein the repeating units A″-O can be identical or different;
A′ is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group;
B is selected from a covalent bond, alkanediyl having 1 to 20 carbon atoms, wherein 2 joined together CH₂ groups can be jointly replaced by a C₅-C₇-cycloalkanediyl group, and C₆-C₁₄-arylenediyl, which is unsubstituted or has 1 or 2 substituents, which are selected from C₁-C₄-alkyl, C₁-C₄-alkoxy and SO₃H, and
B′ is selected from alkanediyl radicals having 4 to 20 carbon atoms.

2. The composition according to claim 1, which comprises 0.05% by weight to 20% by weight of the oligoamide.

3. The composition according to claim 1, which comprises the oligoamide applied to a water-insoluble cloth.

4. A method of preparing a textile detergent composition, the method comprising providing a textile detergent composition and adding the oligoamide of claim 1.

5. A method of avoiding the transfer of textile dyes from colored textiles to uncolored or differently colored textiles, the method comprising providing a surfactant-containing aqueous solutions, and adding the oligoamide of claim 1.

6. A method for washing colored textiles in surfactant-containing aqueous solutions, the method comprising providing a surfactant-containing aqueous solution comprising the oligoamide of claim 1, adding a colored textile, and washing the color textile.

7. The composition of claim 1, wherein the oligoamides are obtained by reacting
a) at least one amino compound having 2 primary amino groups selected from compounds of the formula V1
H₂N-A-NH₂ (V1)
wherein A is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A″, in which A″ is C₂-C₄-alkanediyl and p is an integer in the range from 1 to 20, where the repeat units A″-O can be identical or different,
with
b) at least one amide-forming compound selected from dicarboxylic acids, their amide-forming derivatives, and lactams.

8. The composition of claim 7, wherein the amide-forming compound is selected from dicarboxylic acids of the formula V2
HOOC—B—COOH (V2)
and amide-forming derivatives thereof, wherein
B is selected from a covalent bond,
alkanediyl radicals having 1 to 20 carbon atoms, wherein 2 joined together CH₂ groups can be jointly replaced by a C₅-C₇-cycloalkanediyl group, and
arylene, which is unsubstituted or has 1, 2 or 3 substituents, which are selected from C₁-C₄-alkyl, C₁-C₄-alkoxy and SO₃H.

9. The composition of claim 7, wherein the amide-forming compound is selected from lactams and mixtures thereof with dicarboxylic acids or with amide-forming derivatives thereof.

10. The composition of claim 7, wherein the oligoamides have at least one of the following features i) to iv):
i) the oligoamides are water-insoluble and particulate, wherein the oligoamide particles have particle sizes in the range from 1 nm to 500 μm,
ii) the oligoamides are water-insoluble and particulate, where the average particle size (weight-average) of the oligoamide particles is in the range from 5 nm to 100 μm,
iii) the oligoamides have less than 100 μm/g of carboxyl groups, and
iv) the oligoamides have a number-average molecular weight in the range from 200 g/mol to 5000 g/mol.

11. An oligoamide having at least 750 μmol/g of basic amino groups and a number-average molecular weight in the range from 200 g/mol to 5000 g/mol, and consisting essentially of repeating units of formulae Ia and/or Ib and optionally branching units of formulae II and/or II′, 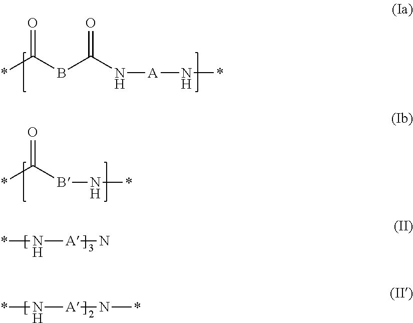
wherein
A is selected from alkanediyl radicals having 2 to 20 carbon atoms, wherein 1, 2, 3, 4 or 5 nonadjacent CH₂ groups can be replaced by a corresponding number of NH groups, and/or in which 2 joined together CH₂ groups can be jointly replaced by a C₅-C₇-cycloalkanediyl group, and groups of the formula (A″-O)ₚ-A′, in which A″ is C₂-C₄-alkanediyl, and p is an integer in the range from 1 to 20, where the repeat units A″-O can be identical or different,
A′ is selected from alkanediyl radicals having 1 to 20 carbon atoms, wherein 1, 2, 3, 4 or 5 nonadjacent CH₂ groups are replaced by a corresponding number of NH groups, and/or in which 2 joined together CH₂ groups are jointly replaced by a C₅-C₇-cycloalkanediyl group;
B is selected from a covalent bond, alkanediyl radicals having 1 to 20 carbon atoms, wherein 2 joined together CH₂ groups are jointly replaced by a C₅-C₇-cycloalkanediyl group, and C₆-C₁₄-arylenediyl, which is unsubstituted or has 1 or 2 substituents, which are selected from C₁-C₄-alkyl, C₁-C₄-alkoxy and SO₃H, and
B′ is selected from alkanediyl radicals having 4 to 20 carbon atoms.

12. The oligoamide according to claim 11, which is obtained by reacting
a) at least one amino compound having 2 primary amino groups selected from compounds of the formula V1
H₂N-A-NH₂ (V1)
wherein A is selected from alkanediyl radicals having 2 to 20 carbon atoms, wherein 1, 2, 3, 4 or 5 nonadjacent CH₂ groups are replaced by a corresponding number of NH groups, and/or in which 2 joined together CH₂ groups are jointly replaced by a C₅-C₇-cycloalkanediyl group, and groups of the formula (A″-O)ₚ-A″, in which A″ is C₂-C₄-alkanediyl and p is an integer in the range from 1 to 20, wherein the repeating units A″-O can be identical or different,
with
b) at least one amide-forming compound selected from dicarboxylic acids, their amide-forming derivatives and lactams.

13. The oligoamide according to claim 12, wherein the amide-forming compound is selected from dicarboxylic acids of the formula V2
HOOC—B—COOH (V2)
and amide-forming derivatives thereof, wherein
B is selected from a covalent bond,
alkanediyl radicals having 1 to 20 carbon atoms, in which 2 joined together CH₂ groups are jointly replaced by a C₅-C₇-cycloalkanediyl group, and
arylene, which is unsubstituted or has 1, 2 or 3 substituents, which are selected from C₁-C₄-alkyl, C₁-C₄-alkoxy and SO₃H.

14. The oligoamide according to claim 12, where the amide-forming compound is selected from lactams and mixtures thereof with dicarboxylic acids or with amide-forming derivatives thereof.

15. The oligoamide of claim 11, having at least one of the following features i) to iv):
i) the oligoamides are water-insoluble and particulate, wherein the oligoamide particles have particle sizes in the range from 1 nm to 500 μm,
ii) the oligoamides are water-insoluble and particulate, wherein the average particle size (weight-average) of the oligoamide particles is in the range from 5 nm to 100 μm,
iii) the oligoamides have less than 100 μm/g of carboxyl groups, and
iv) the oligoamides have a number-average molecular weight in the range from 200 g/mol to 5000 g/mol.

16. The composition of claim 8, wherein B is 1,4-butanediyl.

17. The composition of claim 9, wherein the lactam comprises caprolactam.

18. The oligoamide of claim 13, wherein B is 1,4-butanediyl.

19. The oligoamide of claim 14, wherein the lactam comprises caprolactam.
